(19) United States
(12) Patent Application Publication
(10) Pub. No.: US 2023/0331136 A1
(43) Pub. Date: Oct. 19, 2023

(54) Biomass Delivery System

(71) Applicant: Arbor Fuel Technologies, LLC, North Anson, ME (US)

(72) Inventors: Blaine Miller, Embden, ME (US); Brian Souers, Lincoln, ME (US); Jotham Miller, Anson, ME (US)

(21) Appl. No.: 18/300,099

(22) Filed: Apr. 13, 2023

Related U.S. Application Data
(60) Provisional application No. 63/330,540, filed on Apr. 13, 2022.

(51) Int. Cl. B60P 1/56; B60P 1/40; B60P 1/58; B60P 9/00

(52) U.S. Cl. CPC B60P 1/56; B60P 1/40; B60P 1/58; B60P 9/00

(57) ABSTRACT

A biomass delivery system includes: a vehicle chassis assembly; a cab assembly coupled to the vehicle chassis assembly; a material hopper assembly coupled to the vehicle chassis assembly and configured to receive biomass material; a biomass unloading system configured to remove the biomass material from the delivery hopper assembly; and a screening assembly configured to receive biomass material from the biomass unloading system and filter the biomass material to pass properly-sized biomass material while removing oversize biomass material.

### RELATED APPLICATION(S)

This application claims the benefit of U.S. Provisional Application No. 63/330,540, filed on 13 Apr. 2022, the entire contents of which are incorporated herein by reference.

### TECHNICAL FIELD

This disclosure relates to biomass delivery systems and, more particularly, to biomass delivery systems for distributing green wood chips.

### BACKGROUND

Woody biomass chips have been used as fuel for heat and electrical generation for years, wherein these wood chips are hauled to a mill location and arrive with a moisture content varying from the high thirties to over fifty percent moisture content. While such high-moisture wood chips work for large boiler systems that are often co-fired with other combustible products (e.g., fuel oil), such high-moisture chips do not work for smaller boiler systems.

For example, chips that are produced in the woods during harvest operations often vary greatly in shape and size. And while this may work in the larger/industrial boiler environment where the feed systems are substantial and can accommodate oversized wood chunks, the smaller/residential boiler systems may need chips that are within the size requirements for that particular feed system. Specifically, oversize wood chips may clog such smaller/residential boiler systems.

Another important aspect that may limit the firing of such high-moisture wood chips in small/residential boilers is that these high-moisture wood chips may have a moisture content that exceeds what these smaller/residential boilers can efficiently burn (or even burn at all), wherein high-moisture hardwood chips may have a moisture content of 38-45% moisture and high-moisture softwood chips may have a moisture content of 45-55%.

Unfortunately, the preprocessing of green woodchips to dry them to the point that they are efficiently combustible within smaller/residential boilers (approximately 20% moisture content) is a time-consuming task, as is the process of transporting such green woodchips to the site of smaller/residential boilers.

### SUMMARY OF DISCLOSURE

In one implementation, a biomass delivery system includes: a vehicle chassis assembly; a cab assembly coupled to the vehicle chassis assembly; a material hopper assembly coupled to the vehicle chassis assembly and configured to receive biomass material; a biomass unloading system configured to remove the biomass material from the material hopper assembly; and a screening assembly configured to receive biomass material from the biomass unloading system and filter the biomass material to pass properly-sized biomass material while removing oversize biomass material.

One or more of the following features may be included. The material hopper assembly may be a top load hopper assembly configured to receive the biomass material through the top of the material hopper assembly. The material hopper assembly may be a rear load hopper assembly configured to receive the biomass material through the rear of the material hopper assembly. The biomass unloading system may include a live floor assembly positioned within the material hopper assembly. The biomass unloading system may include an auger assembly positioned within the material hopper assembly. The screening assembly may include a vibrating screening assembly. A grinding assembly may be configured to process the oversize biomass material received from the screening assembly to produce reduced size biomass material. The grinding assembly may be configured to provide the reduced size biomass material into the material hopper assembly. A hopper heating assembly may be configured to warm the biomass material within the material hopper assembly. The hopper heating assembly may be configured to be energized with engine waste heat. A distribution hopper assembly may be configured to receive the properly-sized biomass material from the screening assembly. A biomass material distribution system may be configured to receive the properly-sized biomass material from the distribution hopper assembly and deliver the properly-sized biomass material to a biomass processing system. The biomass material distribution system may be a powered biomass material distribution system. The biomass material distribution system may be an unpowered biomass material distribution system.

In another implementation, a biomass delivery system includes: a vehicle chassis assembly; a cab assembly coupled to the vehicle chassis assembly; a material hopper assembly coupled to the vehicle chassis assembly and configured to receive biomass material; a biomass unloading system configured to remove the biomass material from the material hopper assembly; a screening assembly configured to receive biomass material from the biomass unloading system and filter the biomass material to pass properly-sized biomass material while removing oversize biomass material; and a grinding assembly configured to process the oversize biomass material received from the screening assembly to produce reduced size biomass material.

One or more of the following features may be included. The grinding assembly may be configured to provide the reduced size biomass material into the material hopper assembly. A distribution hopper assembly may be configured to receive the properly-sized biomass material from the screening assembly. A biomass material distribution system may be configured to receive the properly-sized biomass material from the distribution hopper assembly and deliver the properly-sized biomass material to a biomass processing system.

In another implementation, a biomass delivery system includes: a vehicle chassis assembly; a cab assembly coupled to the vehicle chassis assembly; a material hopper assembly coupled to the vehicle chassis assembly and configured to receive biomass material; a biomass unloading system configured to remove the biomass material from the material hopper assembly; a screening assembly configured to receive biomass material from the biomass unloading system and filter the biomass material to pass properly-sized biomass material while removing oversize biomass material; a grinding assembly configured to process the oversize biomass material received from the screening assembly to produce reduced size biomass material; a hopper heating assembly configured to warm the biomass material within the material hopper assembly; and a distribution hopper assembly configured to receive the properly-sized biomass material from the screening assembly.

One or more of the following features may be included. The grinding assembly may be configured to provide the reduced size biomass material into the material hopper assembly. The hopper heating assembly may be configured to be energized with engine waste heat. A biomass material distribution system may be configured to receive the properly-sized biomass material from the distribution hopper assembly and deliver the properly-sized biomass material to a biomass processing system.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a biomass delivery system for distributing green biomass material according to an embodiment of the present disclosure;

FIG. 2 is a diagrammatic view of a biomass processing system coupled to a combustion system for receiving the green biomass material from the biomass delivery system of FIG. 1; and

FIG. 3 is a perspective view of a hopper system of the biomass processing system of FIG. 2.

Like reference symbols in the various drawings indicate like elements.

### DETAILED DESCRIPTION OF THE PREFERRED EMBODIMENTS

### Biomass Delivery System

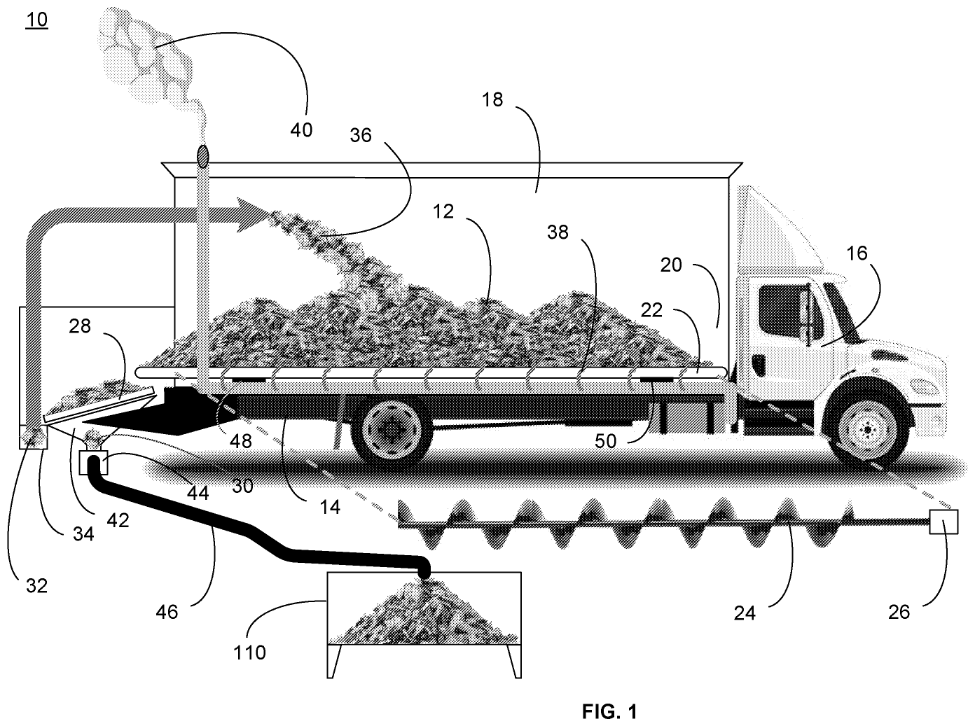

Referring to FIG. 1, there is shown a biomass delivery system (e.g., biomass delivery system 10). Biomass delivery system 10 may be utilized to distribute biomass material 12 to consumers so that they may use such biomass material 12 to e.g., generate heat (via combustion) and/or generate electricity (via a boiler to generate steam that spins a generator).

As is known in the art, biomass material (e.g., biomass material 12) may refer to any type of biological material that is derived from living or recently living organisms, such as plants, animals, or microorganisms. Biomass material (e.g., biomass material 12) may include a wide variety of organic matter, including but not limited to:
i. Wood: Biomass material (e.g., biomass material 12) may be in the form of wood chips, sawdust, bark, and other woody residues from forestry operations or wood processing industries.
ii. Crop Residues: Agricultural crop residues such as corn stalks, wheat straw, rice husks, and sugarcane bagasse may also be used as biomass material.
iii. Energy Crops: Certain crops like switchgrass, miscanthus, and giant reed may be specifically grown for use as biomass material due to their high energy content and ability to be grown in large quantities.
iv. Algae: Microscopic algae may be cultivated and harvested to be used as biomass material for biofuel production.
v. Animal Manure: Livestock manure and poultry litter may be used as biomass material for biogas production through anaerobic digestion.
vi. Food and Yard Waste: Organic waste from food processing, restaurants, and households, as well as yard waste like leaves and grass clippings, may be utilized as biomass material for composting or bioenergy production.
vii. Aquatic Biomass: Aquatic plants, such as water hyacinths, may be harvested from lakes, rivers, and other water bodies and used as biomass material for various applications.

Biomass material (e.g., biomass material 12) may be converted into various forms of energy, such as heat, electricity, and biofuels, through processes like combustion, gasification, anaerobic digestion, and fermentation. Biomass material (e.g., biomass material 12) may be considered a renewable energy source because it is derived from living or recently living organisms and can be replenished through natural processes. For the following discussion, the biomass material (e.g., biomass material 12) is discussed as being in the form of wood chips, sawdust, bark, and other woody residues from forestry operations or wood processing industries.

The biomass delivery system (e.g., biomass delivery system 10) may include a vehicle chassis assembly (e.g., vehicle chassis assembly 14). This size/strength of vehicle chassis assembly 14 may be sized based, at least in part, upon the quantity of biomass material 12 that biomass delivery system 10 is designed to haul. The biomass delivery system (e.g., biomass delivery system 10) may include a cab assembly (e.g., cab assembly 16) coupled to the vehicle chassis assembly (e.g., vehicle chassis assembly 14). Cab assembly 16 may be configured to allow a driver (not shown) of biomass delivery system 10 to obtain loads of biomass material 12 (e.g., from a saw mill/forestry harvesting operation) and distribute portions of biomass material 12 to consumers of the same.

The biomass delivery system (e.g., biomass delivery system 10) may include a material hopper assembly (e.g., material hopper assembly 18) coupled to the vehicle chassis assembly (e.g., vehicle chassis assembly 14) and configured to receive the biomass material (e.g., biomass material 12).

The material hopper assembly (e.g., material hopper assembly 18) may be a top load hopper assembly configured to receive the biomass material (e.g., biomass material 12) through the top of the material hopper assembly (e.g., material hopper assembly 18). For example, material hopper assembly 18 may be an open top hopper assembly that is loaded with biomass material 12 via a payloader (not shown) that loads biomass material 12 through the top of material hopper assembly 18.

Additionally/alternatively, the material hopper assembly (e.g., material hopper assembly 18) may be a rear load hopper assembly configured to receive the biomass material (e.g., biomass material 12) through the rear of the material hopper assembly (e.g., material hopper assembly 18). For example, material hopper assembly 18 may be a closed top hopper assembly that is loaded with biomass material 12 via an opening in the rear of material hopper assembly 18 through which biomass material 12 is blown as the output a chipper assembly (not shown).

The biomass delivery system (e.g., biomass delivery system 10) may include a biomass unloading system (e.g., biomass unloading system 20) configured to remove the biomass material (e.g., biomass material 12) from the material hopper assembly (e.g., material hopper assembly 18).

The biomass unloading system (e.g., biomass unloading system 20) may include a live floor assembly (e.g., live floor assembly 22) positioned within the material hopper assembly (e.g., material hopper assembly 18).

As is known in the art, a live floor assembly (e.g., live floor assembly 22) is a mechanical system used in certain types of trailers or conveyors that is designed to transport bulk materials, such as biomass, wood chips, or other loose or granular materials, without the need for external unloading equipment, such as a dump truck or conveyor belt.

A live floor assembly (e.g., live floor assembly 22) typically consists of a series of slats or panels that are connected to each other and mounted on a trailer or conveyor bed. These slats or panels are typically made of durable materials, such as steel or composite materials, and are designed to move in a reciprocating or oscillating motion. The motion of the slats or panels is powered by a hydraulic or mechanical system, which causes them to move in a wave-like pattern, pushing the material along the length of the material hopper assembly (e.g., material hopper assembly 18).

The live floor assembly (e.g., live floor assembly 22) is used to transport bulk materials in a controlled and efficient manner, allowing for continuous discharge of the material (e.g., biomass material 12) without the need for tipping or dumping the trailer or conveyor. This makes it suitable for applications where the material (e.g., biomass material 12) needs to be continuously unloaded, such as in biomass processing facilities, wood chip handling operations, or waste management facilities.

The live floor assembly (e.g., live floor assembly 22) can be operated by a control system that allows for variable speed and direction of the slats or panels, providing flexibility in the unloading process. It can be used in various types of trailers, such as walking floor trailers, live bottom trailers, or in conveyor systems, where it can be integrated into a conveyor bed for material handling purposes.

Live floor assemblies are commonly used in industries where efficient and automated handling of bulk materials is required, providing a means of transporting materials without the need for manual labor or additional equipment for unloading.

Additionally/alternatively, the biomass unloading system (e.g., biomass unloading system 20) may include an auger assembly (e.g., auger assembly 24) positioned within the material hopper assembly (e.g., material hopper assembly 18). Specific examples of auger assembly 24 may include but are not limited to an electric-based or hydraulic-based auger assembly 24, wherein electric-based or hydraulic-based auger assembly 24 may be powered by motor 26 (e.g., an electric motor or a hydraulic motor).

The biomass delivery system (e.g., biomass delivery system 10) may include a screening assembly (e.g., screening assembly 28) configured to receive biomass material (e.g., biomass material 12) from the biomass unloading system (e.g., biomass unloading system 20) and filter the biomass material (e.g., biomass material 12) to pass properly-sized biomass material (e.g., properly-sized biomass material 30) while removing oversize biomass material (e.g., oversize biomass material 32).

The screening assembly (e.g., screening assembly 26) may include a vibrating screening assembly. As is known in the art, a vibrating screen assembly is a type of mechanical screening equipment that is used to separate particles of different sizes or shapes in a material stream. It typically consists of a frame, a screen panel, and a vibration mechanism.

The frame of a vibrating screen assembly provides the structural support for the screen panel and the vibration mechanism. It is usually made of steel or other durable materials and is designed to withstand the forces generated during the screening process.

The screen panel is the actual screening surface of the vibrating screen assembly. It can be made of various materials, such as wire mesh, polyurethane, or rubber, and is typically mounted on the frame. The screen panel has openings of different sizes, which allow particles of certain sizes to pass through while retaining larger particles.

The vibration mechanism is responsible for generating the vibratory motion that causes the particles to move on the screen panel. It typically consists of one or more vibratory motors or eccentric shafts that rotate or oscillate, producing a vibration that is transmitted to the screen panel through springs or other means. The vibration of the screen panel helps to stratify the material on the screen surface, allowing smaller particles (e.g., properly-sized biomass material 30) to pass through and larger particles (e.g., oversize biomass material 32) to be retained and discharged.

Vibrating screen assemblies are commonly used in various industries, such as mining, quarrying, construction, recycling, and chemical processing, for separating and classifying materials based on their size or other characteristics. They are available in various configurations, such as inclined screens, horizontal screens, and multi-deck screens, to suit different application requirements.

The biomass delivery system (e.g., biomass delivery system 10) may include a grinding assembly (e.g., grinding assembly 34) configured to process the oversize biomass material (e.g., oversize biomass material 32) received from the screening assembly (e.g., screening assembly 28) to produce reduced size biomass material (e.g., reduced size biomass material 36). The grinding assembly (e.g., grinding assembly 34) may be configured to provide the reduced size biomass material (e.g., reduced size biomass material 36) into the material hopper assembly (e.g., material hopper assembly 18).

The biomass delivery system (e.g., biomass delivery system 10) may include a hopper heating assembly (e.g., hopper heating assembly 38) configured to warm the biomass material (e.g., biomass material 12) within the material hopper assembly (e.g., material hopper assembly 18), wherein the hopper heating assembly (e.g., hopper heating assembly 38) may be configured to be energized with engine waste heat (e.g., via engine exhaust 40). For example, the exhaust from the engine (not shown) that powers biomass delivery system 10 may pass e.g., beneath or within biomass unloading system 20 so that such engine waste heat (e.g., via engine exhaust 40) may be used to warm biomass material 12.

The biomass delivery system (e.g., biomass delivery system 10) may include a distribution hopper assembly (e.g., distribution hopper assembly 42) configured to receive the properly-sized biomass material (e.g., properly-sized biomass material 30) from the screening assembly (e.g., screening assembly 28).

The biomass delivery system (e.g., biomass delivery system 10) may include a biomass material distribution system (e.g., biomass material distribution system 44) configured to receive the properly-sized biomass material (e.g., properly-sized biomass material 30) from the distribution hopper assembly (e.g., distribution hopper assembly 42) and deliver the properly-sized biomass material (e.g., properly-sized biomass material 30) to a biomass processing system (e.g., biomass processing system 110).

The biomass material distribution system (e.g., biomass material distribution system 44) may be a powered biomass material distribution system. For example, biomass material distribution system 44 may include a powered impeller (not shown) that is configured to provide a powered-flow of properly-sized biomass material 30 from distribution hopper assembly 42 to biomass processing system 110 via e.g., distribution hose 46.

The biomass material distribution system (e.g., biomass material distribution system 44) may be an unpowered biomass material distribution system. For example, biomass material distribution system 44 may be is configured to provide a gravity-flow of properly-sized biomass material 30 from distribution hopper assembly 42 to biomass processing system 110 via e.g., distribution hose 46.

The biomass delivery system (e.g., biomass delivery system 10) may include one or more scale assemblies (e.g., scale assemblies 48, 50) that are configured to define the weight/quantity of properly-sized biomass material 30 provided to biomass processing system 110 by e.g., determining the weight of biomass material 12 before and after the distribution of properly-sized biomass material 30 to biomass processing system 110.

### Biomass Processing System

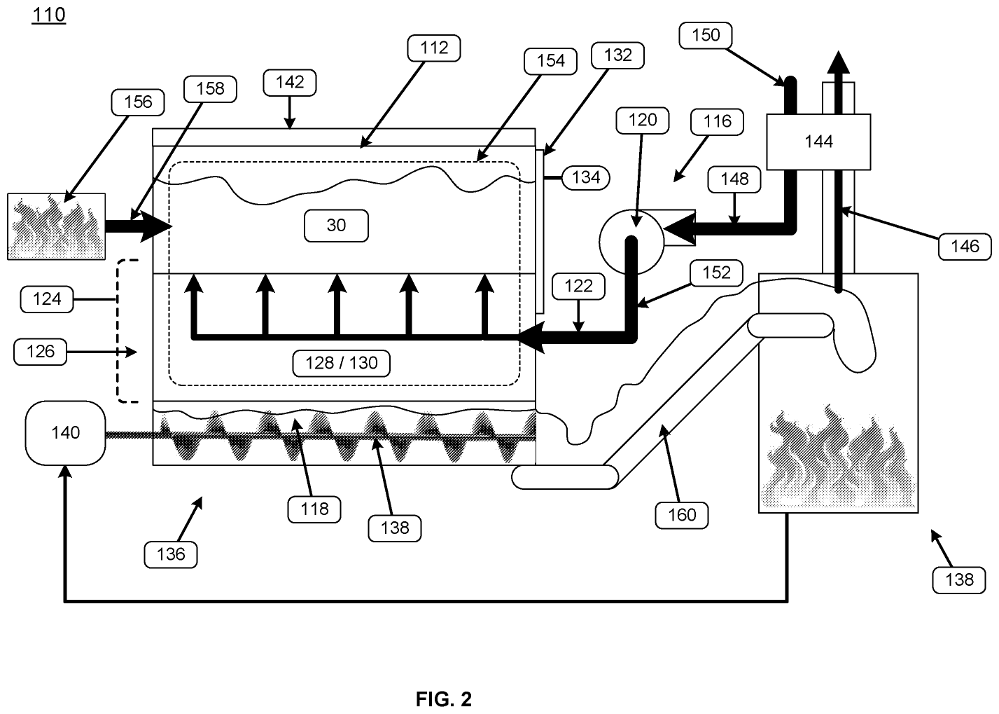

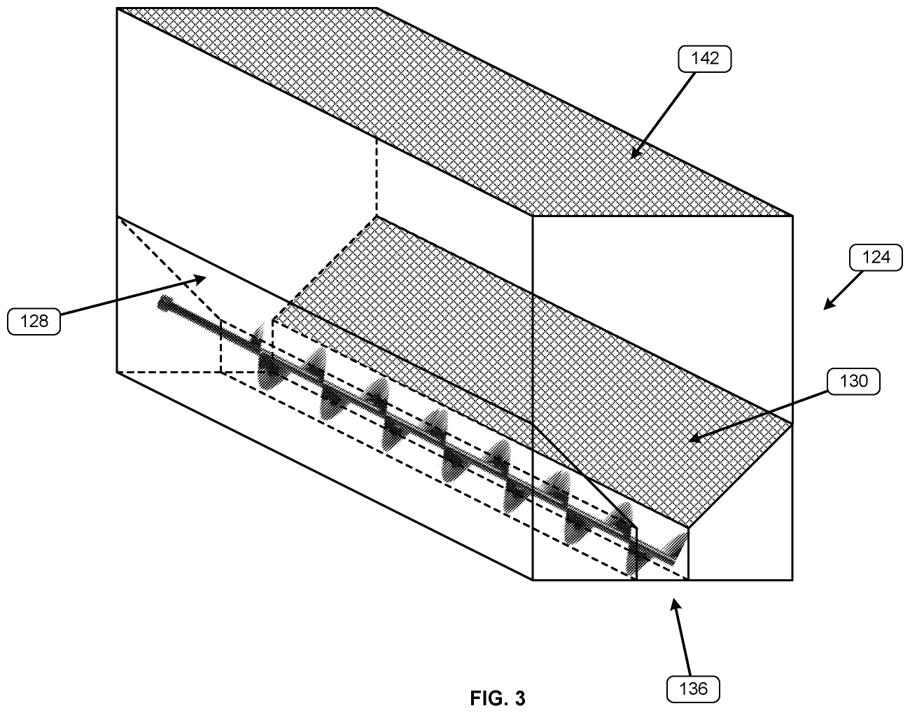

Referring to FIGS. 2-3, there is shown various views of biomass processing system 110 that, as will be discussed below in great detail, may be utilized to dry biomass material (e.g., properly-sized biomass material 30) that may have a moisture content that it too high to be efficiently burned.

Biomass processing system 110 may include hopper assembly 112 that may be configured to receive properly-sized biomass material 30. Properly-sized biomass material 30 may be any high-moisture biomass material, examples of which may include but are not limited to high-moisture wood chips, high-moisture biomass material, and/or any other high-moisture material that may be combustible and may be used as a fuel source.

Hopper assembly 112 may be bin-shaped and may be configured to temporarily store properly-sized biomass material 30 during the drying process. Hopper assembly 112 may be constructed of any material suitable for the type and quantity of properly-sized biomass material 30 being processed, examples of which may include sheet metal (when configured to store lower density/smaller quantities of properly-sized biomass material 30, plate steel (when configured to store higher density/larger quantities of properly-sized biomass material 30, or various composite materials (e.g., fiberglass, carbon fiber, etc.) that may provide a hopper system that is lighter in weight and/or resistant to corrosion.

Biomass processing system 110 may include drying system 116 that may be configured to remove moisture from properly-sized biomass material 30 to generate dried biomass 118. As discussed above, properly-sized biomass material 30 may be a high-moisture biomass material, examples of which may include but are not limited to high-moisture wood chips, high-moisture biomass material, and/or any other high-moisture material that may be used as a fuel source.

For example, properly-sized biomass material 30 may be wood chips that are produced during a tree harvesting operation, wherein these wood chips may be provided to fuel processing system 110 in their “green” (i.e., moist) state. Specifically, properly-sized biomass material 30 may have a moisture content that exceeds what smaller/residential boilers can efficiently burn (or even burn at all), wherein hardwood wood chips may have a moisture content in the range of 38-45% moisture, while softwood wood chips may have a moisture content in the range of 45-55% moisture. Drying system 116 may be configured to reduce the moisture content of properly-sized biomass material 30 down to approximately 12% in a couple of days.

Drying system 16 may include air supply system 120 configured to move drying air 122 through properly-sized biomass material 30 so that dried biomass 118 may be generated. Examples of air supply system 120 may include but are not limited to a fan assembly that may be configured to provide drying air 122.

Hopper system 112 may include perforated portion 124 that may be configured to allow for the passage of drying air 122 through properly-sized biomass material 30, wherein perforated portion 124 of hopper system 112 may be positioned proximate lower portion 126 of hopper system 112.

For example, a lower surface (e.g., lower surfaces 128, 130) of hopper system 112 may be a perforated portion that may be constructed of a mesh material/grate material, wherein (in this example) lower surfaces 128, 130 include perforations large enough to allow for the efficient passage of drying air 122; while small enough to prevent properly-sized biomass material 30 from passing/falling through the perforated portions. Accordingly, if properly-sized biomass material 30 is wood chips that are 2-3 inches in size, the perforated portions (e.g., lower surfaces 128, 130) of hopper system 112 may include a plurality of smaller perforations (e.g., in the range of 1/32^{nd} of an inch to ¼^{th} of an inch) that may allow for the passage of drying air 122 while preventing the 2-3 inch wood chips from falling through these perforated portions of hopper system 112.

Biomass processing system 110 may include level monitoring system 132 configured to determine the quantity of properly-sized biomass material 30 included within hopper assembly 112. Examples of level monitoring system 132 may include any combination of manual systems, electronic systems and automated systems. For example, level monitoring system 132 may include a mechanical sight window that allows an operator (not shown) to physically look into hopper system 112 to see the quantity of properly-sized biomass material 30 within hopper system 112. Additionally, another example of level monitoring system 132 may include an electronic monitoring system that monitors the quantity of properly-sized biomass material 30 within hopper system 112 and provides a signal (e.g., signal 134) to an administrator (not shown), wherein signal 134 may be indicative of the quantity of properly-sized biomass material 30 within hopper system 112. Further, another example of level monitoring system 132 may include an automated electronic system that may monitor the quantity of properly-sized biomass material 30 within hopper system 112 and (at a predefined level) may provide an order signal (e.g., signal 134) to a supplier (not shown) of properly-sized biomass material 30 so that hopper system 112 may be replenished with properly-sized biomass material 30.

Biomass processing system 110 may include material delivery system 136 that may be configured to provide dried biomass 118 to combustion system 138. Examples of combustion system 138 may include but are not limited to a boiler system that may be configured to burn properly-sized biomass material 30.

Examples of the types of material delivery system 136 may include but is not limited to any type of electrical-based system, mechanical-based system, gravity-based system, hydraulic-based system, pneumatic-based system and/or any combinations thereof. Specific examples of material delivery system 136 may include but are not limited to electric-based or hydraulic-based auger system 138 (as shown in FIG. 2), wherein electric-based or hydraulic-based auger system 138 may be powered by motor 140 (e.g., an electric motor or a hydraulic motor). While material delivery system 136 is shown in FIG. 2 to be electric-based or hydraulic-based auger system 138, this is for illustrative purposes only and is not intended to be a limitation of this disclosure, as other configurations are possible and are considered to be within the scope of this disclosure, as other configurations are possible. For example, material delivery system 36 may include an electric-based or hydraulic-based conveyer system.

Hopper system 112 may be configured to direct dried biomass 118 toward material delivery system 136. Accordingly, a lower surface (e.g., lower surfaces 128, 130) of hopper system 112 may be configured (e.g., in the form of a funnel) to direct properly-sized biomass material 30 toward material delivery system 136 (e.g., auger system 138 and/or the conveyor system).

Biomass processing system 110 may include filtering system 142 that may be configured to filter properly-sized biomass material 30 prior to properly-sized biomass material 30 being received by hopper assembly 112. One example of filtering system 142 may include but is not limited to a screening system that may be configured to fit on top of hopper assembly 142, wherein properly-sized biomass material 30 may be loaded into hopper assembly 112 (via e.g., distribution hose 46) through filtering system 142. Filtering system 142 may be sized to allow for the passing of material (e.g., wood chips) into hopper assembly 112 that are small enough to be processed by combustion system 138; while prohibiting the passing of material (e.g., wood chips) into hopper assembly 112 that may be too large to be processed by combustion system 138.

Drying system 116 may further include drying air heating system 144 configured to heat drying air 122. Drying air heating system 144 may allow for the use of biomass processing system 10 in colder climates and may promote more efficient drying of properly-sized biomass material 30. An example of drying air heating system 144 may include but is not limited to a heat exchanger system that may be configured to recover at least a portion of the waste heat generated by combustion system 138. For example, the heat exchanger may be configured to absorb the thermal energy included within exhaust 146 of combustion system 138 by being heated by exhaust 146 of combustion system 138. If the heat exchanger is positioned proximate an inlet (e.g., inlet 148) of drying system 116, the heat absorbed by the heat exchanger may be used to preheat the air (e.g., air 150) provided to drying system 116. Alternatively, if the heat exchanger is positioned proximate an outlet of drying system 152, the heat absorbed by the heat exchanger may be used to heat drying air 122. Alternatively still, drying air heating system 144 may include a combustion-based material heating system configured to burn a combustible fuel (e.g., heating oil, kerosene, propane, natural gas, etc.).

Biomass processing system 110 may include material heating system 154 that may be configured to heat properly-sized biomass material 30 within hopper assembly 112. Material heating system 154 may allow for the use of biomass processing system 110 in colder climates and may allow for the thawing/warming of properly-sized biomass material 30 when such properly-sized biomass material 30 is frozen. An example of material heating system 154 may include but is not limited to a combustion-based material heating system configured to burn combustible fuel 156 (e.g., heating oil, kerosene, propane, natural gas, etc.) so that thermal energy 158 may be provided to hopper system 112 and properly-sized biomass material 30 may be thawed and/or warmed.

During operation, biomass processing system 110 may dry properly-sized biomass material 30 to produce dried biomass 118. Dried biomass 118 extracted from hopper system 112 by material delivery system 136 may be provided to combustion system 138. For example and once dried biomass 118 is extracted from hopper system 112, dried biomass 118 may simply be provided to combustion system 138. Alternatively and as shown in FIG. 2, dried biomass 118 may be provided to feed system 160 (e.g., a conveyor system) that may be configured to provide dried biomass 118 to combustion system 138.

Combustion system 138 may be interfaced with motor 140 that is configured to drive (in this example) auger system 138. Specifically, combustion system 138 may be configured to monitor e.g., the water jacket temperature of combustion system 138, wherein a decrease of the water jacket temperature below a desired set point (e.g., 160 degrees Fahrenheit) may result in the feed rate of material delivery system 136 and/or feed system 160 being increased, while an increase of the water jacket temperature above a desired set point (e.g., 160 degrees Fahrenheit) may result in the feed rate of material delivery system 136 and/or feed system 160 being decreased.

### General

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A biomass delivery system comprising:
a vehicle chassis assembly;
a cab assembly coupled to the vehicle chassis assembly;
a material hopper assembly coupled to the vehicle chassis assembly and configured to receive biomass material;
a biomass unloading system configured to remove the biomass material from the material hopper assembly; and
a screening assembly configured to receive biomass material from the biomass unloading system and filter the biomass material to pass properly-sized biomass material while removing oversize biomass material.

2. The biomass delivery system of claim 1 wherein the material hopper assembly is a top load hopper assembly configured to receive the biomass material through the top of the material hopper assembly.

3. The biomass delivery system of claim 1 wherein the material hopper assembly is a rear load hopper assembly configured to receive the biomass material through the rear of the material hopper assembly.

4. The biomass delivery system of claim 1 wherein the biomass unloading system includes a live floor assembly positioned within the material hopper assembly.

5. The biomass delivery system of claim 1 wherein the biomass unloading system includes an auger assembly positioned within the material hopper assembly.

6. The biomass delivery system of claim 1 wherein the screening assembly includes a vibrating screening assembly.

7. The biomass delivery system of claim 1 further comprising:
a grinding assembly configured to process the oversize biomass material received from the screening assembly to produce reduced size biomass material.

8. The biomass delivery system of claim 7 wherein the grinding assembly is configured to provide the reduced size biomass material into the material hopper assembly.

9. The biomass delivery system of claim 1 further comprising:
a hopper heating assembly configured to warm the biomass material within the material hopper assembly.

10. The biomass delivery systemof claim 9 wherein the hopper heating assembly is configured to be energized with engine waste heat.

11. The biomass delivery system of claim 1 further comprising:
a distribution hopper assembly configured to receive the properly-sized biomass material from the screening assembly.

12. The biomass delivery system of claim 1 further comprising:
a biomass material distribution system configured to receive the properly-sized biomass material from the distribution hopper assembly and deliver the properly-sized biomass material to a biomass processing system.

13. The biomass delivery system of claim 12 wherein the biomass material distribution system is a powered biomass material distribution system.

14. The biomass delivery system of claim 12 wherein the biomass material distribution system is an unpowered biomass material distribution system.

15. A biomass delivery system comprising:
a vehicle chassis assembly;
a cab assembly coupled to the vehicle chassis assembly;
a material hopper assembly coupled to the vehicle chassis assembly and configured to receive biomass material;
a biomass unloading system configured to remove the biomass material from the material hopper assembly;
a screening assembly configured to receive biomass material from the biomass unloading system and filter the biomass material to pass properly-sized biomass material while removing oversize biomass material; and
a grinding assembly configured to process the oversize biomass material received from the screening assembly to produce reduced size biomass material.

16. The biomass delivery system of claim 15 wherein the grinding assembly is configured to provide the reduced size biomass material into the material hopper assembly.

17. The biomass delivery system of claim 15 further comprising:
a distribution hopper assembly configured to receive the properly-sired biomass material from the screening assembly.

18. The biomass delivery system of claim 17 further comprising:
a biomass material distribution system configured to receive the properly-sized biomass material from the distribution hopper assembly and deliver the properly-sized biomass material to a biomass processing system.

19. A biomass delivery system comprising:
a vehicle chassis assembly;
a cab assembly coupled to the vehicle chassis assembly;
a material hopper assembly coupled to the vehicle chassis assembly and configured to receive biomass material;
a biomass unloading system configured to remove the biomass material from the material hopper assembly;
a screening assembly configured to receive biomass material from the biomass unloading system and filter the biomass material to pass properly-sized biomass material while removing oversize biomass material;
a grinding assembly configured to process the oversize biomass material received from the screening assembly to produce reduced size biomass material;
a hopper heating assembly configured to warm the biomass material within the material hopper assembly; and
a distribution hopper assembly configured to receive the properly-sized biomass material from the screening assembly.

20. The biomass delivery system of claim 19 wherein the grinding assembly is configured to provide the reduced size biomass material into the material hopper assembly.

21. The biomass delivery system of claim 19 wherein the hopper heating assembly is configured to be energized with engine waste heat.

22. The biomass delivery system of claim 19 further comprising:
a biomass material distribution system configured to receive the properly-sized biomass material from the distribution hopper assembly and deliver the properly-sized biomass material to a biomass processing system.
